(19) United States
(12) Patent Application Publication
(10) Pub. No.: US 2008/0256605 A1
(43) Pub. Date: Oct. 16, 2008

(54) Localized authorization system in IP networks

(75) Inventor: Jari T. Malinen, Sunnyvale, CA (US)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 10/640,307

(22) Filed: Aug. 14, 2003

(30) Foreign Application Priority Data
Jun. 12, 2003 (EP) 030 13267.4

(51) Int. Cl. G06F 21/02

(52) U.S. Cl. 726/4; 709/229

(57) ABSTRACT

The invention provides a method for bootstrapping a local authorizer of a non-public access network. The local authorizer is arranged for granting access for a client device to the non-public access network. Therefore, the local authorizer includes a credentials database, which is used in authentication and authorization of the client device during access to services or resources of the non-public network. A secret knowledge of the client device is used for generating at least one set of credentials. The bootstrapping method includes the step of uploading the at least one set of credentials to the credentials database of the local authorizer. This upload is performed by the client device at least at first access of the client device to the non-public network. Then the credentials in the credentials database are used for authentication and authorization of the client device during access to the non-public access network.

### BACKGROUND OF THE INVENTION

1. Field of the Invention

The invention relates to a method for bootstrapping a local authorizer of a non-public access network, an authentication and authorization system, a client device for use in the authentication and authorization system and a network element for use in the authentication and authorization system.

2. Description of the Related Art

Access control of remote users has always posed a challenge to network managers as internet service providers (ISP) if they are not a client's home-ISP, for example, in the case of mobile users.

One issue related to access control is authentication being any process by which a network verifies the identity of a user or client, e.g. the user's equipment, who wishes to access the network. Authorization follows the authentication. The authorization includes determining whether the user or client, once identified, is permitted to have access to a certain service or resource owned by the network. This is usually determined by finding out whether a particular user or client is a part of a specified group, or whether that user has a particular level of security clearance. Finally, access control is a much more general way of talking about controlling access to a network service or resource; access can be granted or denied based on a wide variety of criteria, e.g. such as the network address of the user's client, or the time of day.

Because these three aspects are closely related in most applications, it is difficult to separate them from one another. In particular, authentication and authorization are, in most implementations, inextricable.

Authentication may be implemented with so-called credentials. Such a credential may be a pair which includes an attribute together with its respective value, i.e. an attribute value pair (AVP), e.g. a “user ID” and “John DOE,” or “password” and “SESAME”. Alternately, authentication may be implemented with a smart card or an authentication server. Users are often, with or without their knowledge assigned tickets, e.g. a cryptographic string, issued by an authentication server, which certifies the identity of its owner. Tickets are usually time-expired, which are used to track their authentication state. This helps various systems manage access control without frequently asking for new authentication information.

Furthermore, the authentication mechanism, on the one hand, should be as strong as possible and, on the other hand, as simple as possible to minimize network overhead and impact on overall network response times. In networks based on the Internet Protocol (IP), in authorization of services, a protocol such as the early Remote Authentication Dial-In User Service (RADIUS) provides for a method for a user to be authorized to use a network service or network resource.

RADIUS is a protocol, which was defined by the Internet Engineering Task Force (IETF), for administering and securing remote access to a network. In networks using RADIUS, the authentication system includes an authentication server, client protocols, and an accounting server. It works by having a user dial-in to a remote access server (RAS) and passing credentials as authentication information to it. The credentials are forwarded to the authentication server, which validates the user and returns the information necessary for the RAS to initiate a session with the user. A dictionary file kept in a database, e.g. in the authentication server, determines the types of credentials that can be included in the user profile. The user has to repeat this process whenever initiating a new session.

The more recent authorization protocol Diameter is an IETF-defined peer-to-peer protocol for authenticating remote users across a network. Diameter was intended as a supplement or replacement for RADIUS. Both RADIUS and Diameter are “AAA” protocols, i.e. they authenticate (A) and authorize (A) users and perform basic back-end accounting (A) services for bookkeeping purposes. Also like RADIUS, the basic Diameter transaction involves sets of credentials.

Upon receiving an authentication request, a Diameter server typically issues the attribute of a certain credential, for instance, the user or client. ID as a challenge, to which the requesting user or client responds with the respective value, i.e. the ID. Then the server issues the password attribute, to which the requesting user or client responds with the respective value, i.e. the password. If the credentials replied by the user or client are correct, the user is considered authentic.

However, the credential exchange goes beyond simple authentication, and this is where authorization comes in. Through further credentials, the authorization server can further determine specific resources to which the user will be granted access. For instance, access to a high-security application might require the user to supply a private-key code.

The authentication, authorization and accounting process discussed above is also possible with RADIUS but easier to implement with Diameter because Diameter lets a remote server send unsolicited messages to a client. This way, if the user sends only the password, the Diameter-equipped server sends another message, requesting the private-key code. For instance, one Diameter AVP involves “home-agent-address” as the attribute and uses an IP address as the value. This way, a mobile user calling from a mobile phone can use this to pass through to the Diameter server of his home-ISP in order to be authenticated by the user ID and password.

In order to allow for authentication through one or more third parties as an authentication broker, Diameter also enhances the limited proxy capabilities of RADIUS. For that purpose, the remote-ISP is allowed to create a proxy back to the user's home-ISP, and on to the home-ISP Diameter server. From there, the home-ISP and the user can carry on their authentication transaction. Once that is complete, the home-ISP tells the remote-ISP to give the user service. As can be seen, these authentication and authorization processes generate a lot of network traffic.

The Diameter and RADIUS protocols allow a user or client to connect to an authorizing server, or authorizer, which, after the examination of the credentials of the user or client, grants permissions to use a service or resource, such as network access. By providing some additional credentials, such as temporary keys, the service can be used with a temporary security association between the client and the service.

As outlined, RADIUS provides for a straightforward connection to the authorizer. However, when network access authorization is done by the administrator of the access network from a RADIUS server, scaling to multiple administratively disjoint access networks is not easy and causes increase of traffic. Since Diameter allows for scalable separation of the authorizing entity from the network access provider, the user or client can request authorization through a chain of brokers, which propagate authorization requests between different domains providing for a better scalability to a large network administered by many independent organizations, especially when clients are mobile. This general principle is shown in FIG. 1, which is described below in more detail.

However, the authorization always uses the same authorizer directly or indirectly when requesting permission to use a service or resource of the network. In IP-based networks, localizing authorization would need to run two separate protocols, or to have a separate version of a smart card-based protocol, possibly requiring two separate smart cards, one for public and one for local (or home), respectively, network authorizations.

In a large network, authorization from a user or client can also use a mode where a client contains a device. Such device can be a smart card, which is a hardware device used in a cryptographic authentication system. Some smart cards operate on the basis of a frequently changing password, i.e. a user who wishes to login must enter his own user ID and the actual password is displayed by the card. An alternate system uses a cryptographic calculator, where the user logs into a system, which displays a challenge string. The user keys this string into his smart card, which displays a respective response. The response is used as the user's password for the login session. However, for this purpose it is necessary that the smart card and the authorizing network element share a secret knowledge, which is not exchanged during communication. This knowledge can be the algorithm which generates the appropriate value to be repeated to a certain challenge of the other party.

Such device contained in the client may also be a Subscriber Identity Module (SIM) card, which, together with the authorizer, is able to produce a temporary key as a token of authorization to use a network service or network resource. However, again the authorizing protocol has to be able to communicate with an authorizer belonging to the domain who issued the SIM card for the authorizer to grant access to, e.g., an access network which does not belong to the home-ISP of the user.

### SUMMARY OF THE INVENTION

The invention provides a method for setting up a local authorizer, which is able to authorize and authenticate a user or client in a private network without having a public authorizer involved in granting access to resources and services of the private network. Further, the invention provides a system for authorization and authentication, in which the local authorizer is set up. The invention may also be configured so that the set up should not need separate protocols or separate devices.

The invention also provides set up of a local authorizer and an authorization and authentication system without the need to communicate to a central authorization authority, e.g. a public authorization server, during the set up of the local authorizer.

The invention provides a method for setting up an authorization and authentication system in a local private access network, wherein a user not already registered to a database of the local access network for authentication purposes should have access to some or all of the private network services and resources.

Accordingly, the invention provides a method for bootstrapping a local authorizer, e.g. an authorizing server device, of a non-public access network. The local authorizer is arranged for granting permission to a client device to have access to the non-public access network. For that, the method allows for set up of the local authorizer of the non-public access network during at least the first access of the client device to the non-public access network. The local authorizer includes a credentials database used for authentication and authorization of the client device, which is accessing services or resources of the non-public network. A secret knowledge of the client device is used for generating at least one set of credentials. The at least one set of credentials is uploaded to the credentials database of the local authorizer by the client device at least at the first access of the client device to the non-public network. Then the local authorizer uses the credentials in the credentials database for authentication and authorization of the client device during access to the non-public access network.

The public network provides public resources whose owners delegated authorization to the public authorizer. Further, there are local resources owned by the client. With the method of the invention, the client is able to have the same method for authorizing its own resources as the one used by the client when it uses the public network services or resources.

Advantageously, when accessing the non-public network in authentication and authorization of the client device, the same protocol can be used as in authentication and authorization of the client device during access to a public access network.

In one embodiment of the invention, the secret knowledge is a certain algorithm, in particular a cryptographic algorithm. The certain algorithm is adapted for generating credentials from attribute values, which are stored in the client device. Since known protocols do not support reusing these protocols for changing the authorizer to one with no knowledge of the secret algorithm, with the invention this problem is advantageously solved.

The secret knowledge of the client device can be mutual knowledge of the client device and a public authorizer of a public access network about authentication and authorization for providing access to services and resources of the public network. In case the secret knowledge is a certain algorithm, in such an environment, the authorizer of the public network and the client device share the secret algorithm that can produce for instance a session key from a randomly generated challenge. Such challenges can be generated by a random generator contained within the client device or in a smart card contained in the client device. Due to sharing the secret knowledge between the client device and the public authorizer, the public authorizer is able to check a client device's response to a given challenge onto authenticity. The local authorizer of the non-public network does not have knowledge of the secret algorithm. However, with the invention it is possible to use the same authorization protocol when accessing non-public networks as when accessing a public network by a client device.

The sets of credentials in the credentials database may be temporary. For this purpose, in one embodiment of the invention each of the sets of credentials expires after a predetermined period. In another embodiment, each one of the sets of credentials expires after use in the authentication and authorization. Therefore, the invention prevents a third party which might intercept a set of credentials during an authentication and authorization communication between the client device and the local authorizer from using this certain set of credentials.

Actually, the set up of the local authorizer, in particular the step of uploading the set of credentials to the credentials database of the local authorizer, has to take place at least when the client device is started for the first time. However, since in one embodiment of the invention the sets of credentials in the credentials database of the local authorizer are temporary, the step of uploading the at least one set of credentials to the credentials database of the local authorizer may take place when the credentials of the client stored in the credentials database have been exhausted or expired. It should be noted that it is also possible to perform the set up of the credentials database in the local authorizer after manual configuration. Such command can for instance be sent by the user of the client device or the operator of the local network.

In another embodiment of the invention, the step of uploading the at least one set of credentials to the credentials database includes extracting session keys from a smart card, which is contained in the client device. Such smart card can be a subscriber identification module (SIM). Then the set up of the credentials database includes extracting session keys from the SIM and the upload of the session keys as credentials to the credentials database of the local authorizer. It is clear that the secret knowledge according to the invention may also be contained in the smart card itself, i.e. for instance the secret algorithm.

The method of the invention can easily be applied to public networks and non-public networks based on the Internet Protocol (IP) or the Internet Protocol version 6 (IPv6). The invention is most advantageous for scenarios where the non-public network is a local private network owned by the client, for instance, a wireless local area network.

Further, the invention can advantageously be applied to an authentication and authorization system, which is arranged to authorize, or to grant permission to, a user or a client device to have access to a non-public access network having a local authorizer. The local authorizer includes at least the credentials database for use in the authentication and authorization of a client accessing services or resources of the non-public network. According to the invention, a mutual knowledge of the client device and a public authorizer of a public access network about authentication and authorization for providing access to services and/or resources of the public network is used for set up of the local authorizer. Further, in the authentication and authorization of the client device during access to the non-public network the same protocol can be used as in the authentication and authorization of the client device during access to the public access network.

In the authentication and authorization system according to one embodiment of the invention a client device is arranged to perform the set up of the local authorizer in the non-public access network. The client device uses the mutual knowledge of itself and the public authorizer of the public access network used in the authentication and authorization for providing access to the public network. It is understood that it is also possible to have this also implemented on a smart card, e.g. a Subscriber Identification Module (SIM), which is used in the client device. Thus, the client device or the smart card, respectively, performs the upload of the credentials to the credentials database of the local authorizer. The credentials are then used for the authentication and authorization during the access of the client to the non-public network.

In the authentication and authorization system according to one embodiment of the invention on the side of the non-public network administration, a network element is arranged to operate as the local authorizer of the non-public access network. The network element includes the credentials database for storing the sets of credentials provided by the client device at least at a first network access for authentication and authorization in following network access.

Accordingly, the above-described invention can be implemented in present IP-based networks with some modification of authorization, for example, according to the following scenario. A client has some resources in its own private network, which can be a radio access network like a wireless local area network (wireless LAN). Another assumption may be that the mobile client device uses e.g. SIM-based authorization for gaining access to the public IP-based networks and the access node of the client's private network has a similar network in its home domain, and there the owner of the client's private network is the client itself.

The client may be interested in having some other entity, other than the entity in the original protocol used in the public access network, to guard the granting of access. Further, the client may not want to involve the public authorizer in granting access to its own resources, e.g. because a public authorizer may be an additional cost. Furthermore, the client may not want the public authorizer to know all the details of the resources used by the client. Finally, yet importantly, a local domain administrator may want the authorization of local services and resources to belong to the local authorizer set up by the client rather than a public authorizer external to client's home domain. For all these reasons, the client may wish to reuse the same protocol also for local authorization. However, as already mentioned, known protocols do not support the reuse of the authorizer in situations where the authorizer is changed to one with no knowledge of the secret algorithm. The invention solves this situation.

In the method according to the invention described above, a public authorizer is the party, other than the client, knowing the secret algorithm. In other words, a public authorizer is the party that knows the secret algorithm. However, since the client knows the secret algorithm, i.e. the client device has the algorithm implemented as software or as hardware device. Thus, the invention provides a possible method of reusing the authorization mechanism in such a way not suggested in currently used authorization protocols. For this purpose, the method of the invention introduces reuse of authorization mechanisms for setting up the local authorizer. Authorization of the public access network uses the secret algorithm mutually known by the client device (or the smart card in the client device) and a public authorizer. The method according to the invention advantageously has only to be incorporated into the actual used protocols, which are used for authentication and authorization in public networks. Moreover, since this modification comes as an add-on feature, it is fully compatible with the present IP-based networks.

Accordingly, the invention introduces a localized authorization bootstrap where the client uses its knowledge of the secret algorithm to extract from its smart card, e.g. SIM, a limited set of credentials and their respective check values. These sets of credentials are uploaded to the local authorizer of the private network of the client. Now, the client is able to reuse the public protocol for localized access, i.e. it uses the same authentication and authorization procedures with a network, which is configured to propagate requests to the local authorizer. Advantageously, the authentication and authorization protocol adapted according to the invention allows a client to reuse the authorization protocol of a public access network for controlling its own resources. Since the method of the invention can be used with IP or IPv6 protocols, the invention provides a method for immediate cost-efficient control of authorized use for many simple devices and many clients for a domain.

As to the implementation in actual protocols, there is only a need for an add-on to the protocol for bootstrapping or setting up of the local authorizer. This bootstrapping can be run e.g. when a client device is started for the first time, or on manual configuration command, or when the set of temporary keys in the local authorizer have been exhausted. The invention can easily be implemented to a protocol as the proposed SIM6, which is in working progress.

Moreover, the reuse of session key generation and distribution in a client's own network allows for controlling many devices in a practical manner, instead of directly setting associations between the client and all these devices. This amounts to less manual setup work and use of multiple clients in a network so that multiple authorizable resources becomes more cost efficient and scalable. Finally, the user of the method according to the invention does not have to let an external authorizer know or charge for local authorizations.

The above and other objectives, features, and advantages of the invention will become more clear from the following description of the preferred embodiments thereof, taken in conjunction with the accompanying drawings. It is noted that through the drawings, the same or equivalent parts retain the same reference number. All drawings are intended to illustrate some aspects and embodiments of the invention. Moreover, it should be noted that in case of different embodiments only the differences are described in detail. It is understood that not all alternatives and options are shown and therefore, the invention is not limited to the content of the accompanying drawings.

### BRIEF DESCRIPTION OF THE DRAWINGS

In the following, the invention will be described in detail by way of example with reference to the accompanying drawings, in which

FIG. 1 shows a scenario of a client device establishing access to a public network and being authorized via a chain of brokers by a central public authorizer;

FIG. 2 is the scenario of FIG. 1 expanded with the aspect of a additional non-public network which provides access control by a local authorizer according to the invention; and

FIG. 3 depicts by a flow chart the steps which are performed during set up of the local authorizer according to an embodiment of the method of the invention.

### DETAILED DESCRIPTION OF THE PREFERRED EMBODIMENTS

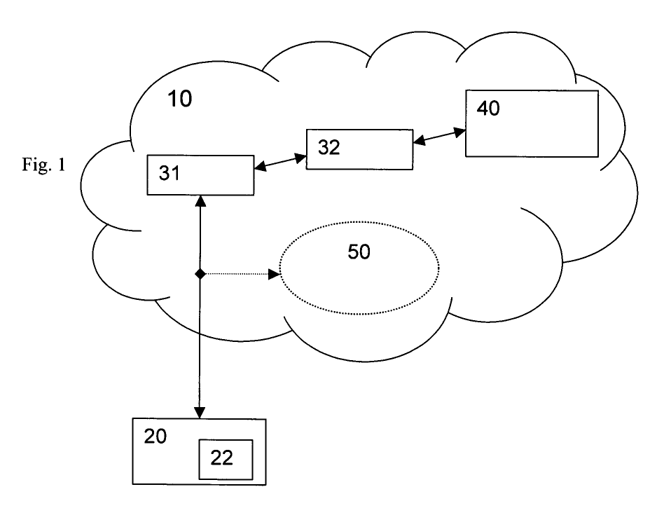

FIG. 1 shows the prior art situation of a public access network 10. A user or client device 20, for instance, a mobile user equipment assumed to have a smart card 22, is accessing the services or resources 50 of the public network 10. Authentication and authorization is performed through a chain of brokers 31, 32 by a public authorizer 40. The public authorizer 40 authorizes, i.e. grants permission, to the client device 20 after authentication to access the public services or resources 50 of the public network 10, to which the client device 20 is authorized. The public services or resources 50 can be e.g. wireless LANs whose administrators have delegated access control to the public authorizer 40.

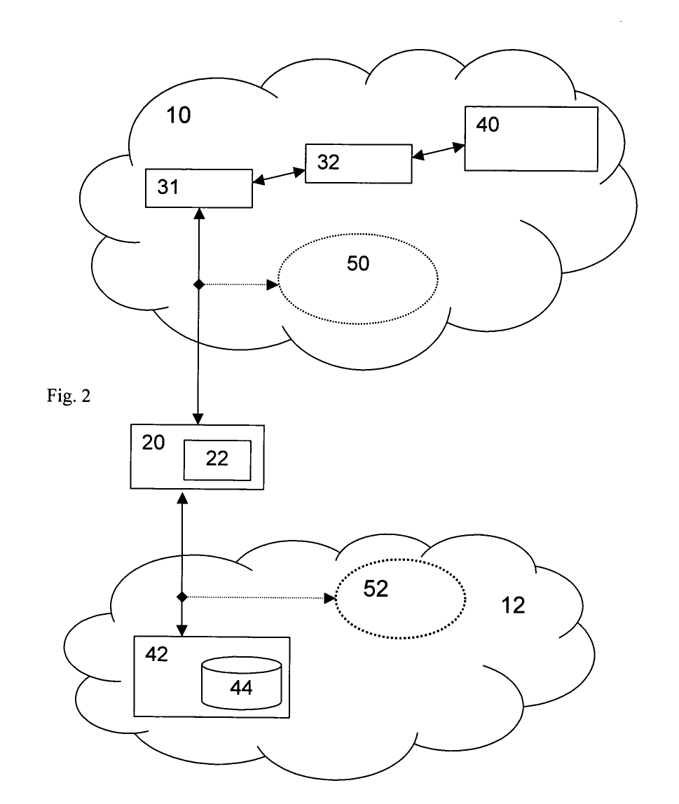

Now referring to the example as depicted in FIG. 2, the user or client device 20 has some services or resources 52 in its own private, i.e. non-public, access network 12, which can be a radio access network like a wireless LAN. As already described, the mobile user or client device 20 includes a smart card 22, e.g. a SIM, and therefore, uses SIM-based authorization for getting access to the public access networks 10. The owner of non-public network 12 is the client itself.

The client may want some other entity other than the one in the original protocol used in the public access network for guarding the granting of the access. Further, the client may not want to involve a public authorizer to grant access to its own resources because public authorizer may be costly. Furthermore, the client may not want a public authorizer to know all of the details of the services and resources that the client is using. Finally, yet importantly, a local administrator in the client's non-public network may want that authorization of the local resources to belong to the local authorizer set up by the client rather than a public authorizer external to client's home domain. For all these reasons, a reuse of the same protocol for public and non-public authorization is desired. However, known protocols do not support reusing them for changing the authorizer to one with no knowledge of the secret algorithm. The invention provides a solution for this situation.

Since both networks, i.e. the public network 10 and the non-public network 12, are IP-based networks, the invention can be implemented with some modification of authorization as is described in the following together with FIG. 2.

The invention allows reuse of the smart card based authorization mechanisms for set up of the local authorizer 42. Therefore, FIG. 2 shows in addition to FIG. 1 local services and resources 52 owned by the client. The local services and resources 52 can be similar to the services and resources of the public access network 10.

In known authorization, a secret algorithm mutually known by the client device 20 or the smart card 22, e.g. SIM, in the client device 20 and the public authorizer 40 is used. With the invention the client is able to have the same method for authorizing its own services and resources 52 as the method used by the client when it uses the public services and resources 50. This helps to simplify the client device 20 in terms of the number of protocols used. Further, the smart card 22 is reused for authorization. Thus, little configuration needs to be done.

Accordingly, the invention introduces a localized authorization bootstrap where the client device 20 uses its knowledge of the secret algorithm to extract from its smart card 22 a limited set of credentials and their check values and to upload this set to a database 44 of the local authorizer 42. Then the client is able to reuse the protocol for accessing the local non-public network 12, i.e. it uses the same protocol and algorithm with a network configured to propagate such requests to the local authorizer 42.

Now, the use of local authorizer 42 of FIG. 2 is described. The client device 20 uses a certain protocol in a public network 10 for authorization. Now, the client device 20 uses the same protocol for obtaining authorization to use the services and resources 52 of the local non-public network 12. Identities used to identify the requested service and/or to identify the client will tell the authorization infrastructure to route these requests to the localized authorizer 42. Otherwise, the authorization protocol in use should be reusable as is.

This general principle can be applied to IP and IPv6 networks. The invention can use a protocol, such as the SIM6, with an additional protocol for bootstrapping the local authorizer 42 according to the invention. This bootstrapping can be run, for instance, when the client device 20 is started for the first time, or on manual configuration command, or when the set of temporary keys in the credentials database 44 of the local authorizer 42 have been exhausted.

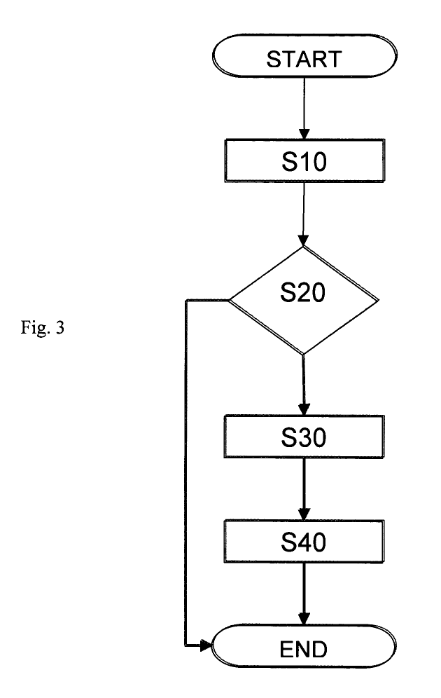

FIG. 3 is a flow diagram, which depicts a generic procedure in an implementation of the bootstrapping procedure for the local authorizer 42 of FIG. 2 according to the invention. For security purposes, it is assumed that there exist secure channels between the client device 20 and the local authorizer 42 as well as authorized local devices and the local authorizer. The local authorizer database bootstrap according to the invention and with respect to FIG. 2 starts with the START step. In step S10, the client device 20 decides to use a service or resource for which it needs an authorization. In step S20, a non-volatile state is checked which tells the client device 20 whether this is the first time for using this locally authorized service. It is also possible that this result is derived from the reaction of the authorizer during communication of the client device 20 with the local authorizer 42. If the second case is true, then this it not the first time that the locally authorized service has been used, the client device 20 has already set up the credentials database 44 of the local authorizer 42 and no bootstrap has to be performed. Therefore, the sub-protocol goes to the END step and terminates. However, it should be noted that there are some other situations that may require bootstrapping of the local authorizer 42, for instance, if the sets of credentials in the credentials database 44 of the local authorizer 42 have expired or have been exhausted. In this case, the outcome of the check in step S20 indicates that there is a need for a set up of the local authorizer 42. Therefore, the process proceeds to step S30. In step S30, the client device 20 locally generates a database of n elements to be uploaded to the authorizer credentials database 44. For example, with smart card 22, for instance, a SIM card the client device 20 generates n challenges from a random generator and extracts the respective n responses from the SIM to obtain the other components of each triplet. After step S30, in step S40 the client device 20 uploads the database of n elements to the credentials database 44 of the local authorizer 42 through a secure channel, e.g. by forming a long encrypted message transmitted from the client device 20 to the credentials database 44 of the local authorizer 42. Now the bootstrap of the local authorizer 42 has been performed and the local authorizer 42 is set up.

The invention has introduced a method for bootstrapping a local authorizer 42 of a non-public access network 12. The local authorizer 42 is arranged for granting access for a client device 20 to the non-public access network 12. For this purpose, the local authorizer 42 includes a credentials database 44, which is used in authentication and authorization of the client device 20 during access to services or resources 52 of the non-public network 12. A secret knowledge of the client device 20 is used for generating at least one set of credentials. The bootstrapping method includes the step of uploading the at least one set of credentials to the credentials database 44 of the local authorizer 42. This upload is done by the client device 20 at least at the first access of the client device 20 to the non-public network 12. Then the credentials in the credentials database 44 are used for authentication and authorization of the client device 20 during access to the non-public access network 12. Thus, the client device 20 can advantageously reuse the public protocol for localized access, i.e. it can use the same protocol and algorithm with a network, which is configured to propagate requests to the local authorizer 42. Since the method of the invention can be used with IP or IPv6 protocols, it provides a method for immediate cost-efficient control of authorized use for many simple devices and many clients for a domain.

1. A method for bootstrapping a local authorizer, wherein the local authorizer is configured to grant access for a client device to a non-public access network and the local authorizer comprises a credentials database used for authentication and authorization of the client device accessing services or resources of the non-public network, the method comprising:
generating at least one set of credentials by using a secret knowledge of the client device;
uploading the at least one set of credentials to the credentials database of the local authorizer by the client device at least during a first access of the client device to the non-public network; and
using the at least one set of credentials in the credentials database for the authentication and authorization of the client device during access to the non-public access network,
wherein a credential comprises a pair which includes an attribute together with its respective value.

2. The method according to claim 1, wherein the using comprises using a same protocol during the authentication and authorization of the client device when accessing the non-public network and during the authentication and authorization of the client device when accessing a public access network.

3. The method according to claim 1, wherein the generating comprises using the secret knowledge, which is of mutual knowledge to the client device and a public authorizer of a public access network, for the authentication and authorization for providing access to services and resources of the public network.

4. The method according to claim 3, wherein the generating comprises using the secret knowledge comprising an algorithm.

5. The method according to claim 4, wherein the generating comprises generating the set of credentials, which is at least a random number, using a random generator which is included in the client device, and generating a corresponding value using the algorithm from at least the random number.

6. The method according to claim 1, wherein the uploading comprises uploading the at least one set of credentials in the credentials database temporarily.

7. The method according to claim 6, wherein the uploading comprises uploading the at least one set of credentials so that the at least one set of credentials expires after a predetermined period.

8. The method according to claim 6, wherein the uploading comprises uploading the at least one set of credentials so that the at least one set of credentials expires after first use.

9. The method according to claim 1, wherein the generating and uploading comprise generating and uploading the at least one set of credentials to the credentials database of the local authorizer occur when the client device is started for a first time.

10. The method according to claim 1, wherein the generating and uploading comprise generating and uploading the at least one set of credentials to the credentials database of the local authorizer occur when the at least one set of credentials of the client device stored in the credentials database have been exhausted.

11. The method according to claim 1, wherein the generating and uploading comprise generating and uploading the at least one set of credentials to the credentials database to the local authorizer are initiated by a manual configuration command.

12. The method according to claim 1, wherein the further comprise extracting session keys from a smart card, which is contained in the client device.

13. The method according to claim 12, wherein the extracting comprises extracting the session keys from the smart card comprising a subscriber identification module.

14. The method according to claim 1, wherein the uploading comprises uploading to the non-public network, wherein the non-public network and a public network are networks based on an Internet Protocol or an Internet Protocol 6.

15. The method according to claim 1, wherein the uploading comprises uploading to the non-public network comprising a local network owned by an owner of the client device.

16. An authentication and authorization system comprising:
a client device; and
a non-public access network, wherein the non-public access network comprises a local authorizer,
wherein the local authorizer comprises a credentials database for use in authentication and authorization of the client device accessing services or resources of the non-public network, wherein a mutual knowledge of the client device and a public authorizer of a public access network about the authentication and authorization for granting the client device access to services or resources of the public network is used for setting up the local authorizer by uploading of credentials to the credentials database; and
wherein a same protocol is used during the authentication and authorization of the client device when accessing the non-public network and during the authentication and authorization of the client device when accessing the public access network,
wherein the authentication and authorization system is configured to grant access of the client device to the non-public access network, and
wherein a credential comprises a pair which includes an attribute together with its respective value.

17. The authentication and authorization system as recited in claim 16, wherein the client device is configured to perform the set up of the local authorizer in the non-public access network by use of the mutual knowledge for generating at least one set of credentials and for uploading the at least one set of credentials to the credentials database of the local authorizer, wherein the at least one set of credentials are used for the authentication and authorization when the client device accesses to the non-public network.

18. The authentication and authorization system as recited in claim 17, wherein the client device comprises a smart card, or a Subscriber Identification Module, containing the mutual knowledge.

19. The authentication and authorization system as recited in claim 16, further comprising:
a network element configured to operate as the local authorizer of the non-public access network and comprising the credentials database for storing the credentials uploaded by the client device for the authentication and authorization in the non-public access network during at least at a first network access to the non-public access network.

20. A client device comprising:
a protocol for use at least in authentication and authorization during access to an access network and a secret knowledge about the authentication and authorization in a public network by means of a public authorizer mutually known by the client device and the public authorizer;
wherein the client device is configured to perform a set up of a local authorizer of a non-public access network by generating at least one set of credentials by use of the secret knowledge and to upload the at least one set of credentials to a credentials database of the local authorizer of the non-public access network,
wherein the at least one set of credentials is used in authentication and authorization of the client device when accessing to services or resources of the non-public network,
wherein the protocol is a same protocol as used during the authentication and authorization of the client device when accessing the non-public network and during the authentication and authorization of the client device when accessing the public access network, and
wherein a credential comprises a pair which includes an attribute together with its respective value.

21. The client device according to claim 20, wherein the client device comprises a smart card, or a Subscriber Identification Module, containing the secret knowledge.

22. A network element comprising:
a credentials database configured to store credentials uploaded by a client device during at least at a first access to a non-public access network of the client device,
wherein the network element is further configured to perform authentication and authorization in the non-public access network by use of at least one set of credentials and to grant access of the client device to services or resources of the non-public network,
wherein a protocol used in the authentication and authorization is a same protocol as used in the authentication and authorization of the client device when accessing the non-public network and when accessing a public network, and
wherein a credential comprises a pair which includes an attribute together with its respective value.

23. The network element according to claim 22, wherein a secret knowledge of the client device and a public authorizer of a public access network about authentication and authorization is used for generating the credentials by the client device.

24. A system for bootstrapping a local authorizer, the system comprising:
generating means for generating at least one set of credentials by using a secret knowledge of a client device, wherein the local authorizer is configured to grant access for a client device to a non-public access network and the local authorizer comprises a credentials database used for authentication and authorization of the client device accessing services or resources of the non-public network;
uploading means for uploading the at least one set of credentials to the credentials database of the local authorizer by the client device at least during a first access of the client device to the non-public network; and
using means for using the at least one set of credentials in the credentials database for the authentication and authorization of the client device during access to the non-public access network,
wherein a credential comprises a pair which includes an attribute together with its respective value.
